(19) United States
(12) Patent Application Publication
(10) Pub. No.: US 2003/0068974 A1
(43) Pub. Date: Apr. 10, 2003

(54) Method and apparatus for delivering personalized and location sensitive information to a user device

(75) Inventors: Sridhar Kanamaluru, West Windsor, NJ (US); John Riganati, Skillman, NJ (US); Zygmond Turski, Florence, NJ (US); Raymond Camisa, East Windsor, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/825,198

(22) Filed: Apr. 3, 2001

Related U.S. Application Data
(60) Provisional application No. 60/203,406, filed on May 11, 2000.

(51) Int. Cl. H04H 1/00; H04H 7/00; G06F 3/00; H04N 5/445; G06F 13/00; G09G 5/00

(52) U.S. Cl. 455/3.06; 345/747; 345/745; 455/3.05; 725/46

(57) ABSTRACT

A method and system for delivering personalized, location-sensitive information to a user device comprising an information network interface for collecting, filtering and storing information and a broadcast network for delivering, as broadcast information, some or all of the collected information to a user device. The user device filters the broadcast information in accordance with a user's personal preferences and a user's location.

This application claims benefit of U.S. provisional patent application serial No. 60/203,406, filed May 11, 2000, which is herein incorporated by reference.

The invention generally relates to wireless information distribution systems and, more particularly, the invention relates to a method and apparatus for delivering personalized, location-sensitive information to mobile users using wireless user devices.

### BACKGROUND OF THE INVENTION

In general, mobile professionals or users require access to information from voice, video, internet, and broadcast networks at all times. When these users are mobile, they either completely lose, or have severely limited access to many of these sources of information. Current technologies, which include cellular telephones, laptop personal computers, and hand-held personal data assistants (PDAs), utilize exclusively cellular infrastructure to provide limited access to information on demand, such as voice messages and email, but do not support access to all the information that would be available to users at their homes or offices. Moreover, the information available to mobile users that is provided by current technologies may not be presented in a format that is most conducive for travel. Additionally, information availability is facilitated by a process whereby the user device requests information and the information source supplies the information in response to the request. Such an interactive process involves substantial information availability latency.

Therefore, there exists a need in the art for a method and apparatus for delivering personalized, location-sensitive information to mobile users in a format that is conducive for mobile use.

### SUMMARY OF THE INVENTION

The disadvantages associated with the prior art are overcome by a method and system for delivering personalized, location-sensitive information to a user device comprising an information network interface for collecting, filtering and storing information and a broadcast network for delivering, as broadcast information, some or all of the collected information to a user device. The user device filters the broadcast information in accordance with a user's personal preferences and a user's location. Because the information is broadcast to the user device such that the information is always available, the user experiences no latency with respect to the availability of the information.

### BRIEF DESCRIPTION OF THE DRAWINGS

The teachings of the present invention can be readily understood by considering the following detailed description in conjunction with the accompanying drawings, in which:

FIG. 1 depicts a block diagram of an information distribution system in accordance with the present invention;

FIG. 2 illustrates location-sensing methods of the present invention; and

FIG. 3 depicts an apparatus for receiving information distributed in accordance with the information distribution system of FIG. 1.

To facilitate understanding, identical reference numerals have been used, where possible, to designate identical elements that are common to the figures.

### DETAILED DESCRIPTION

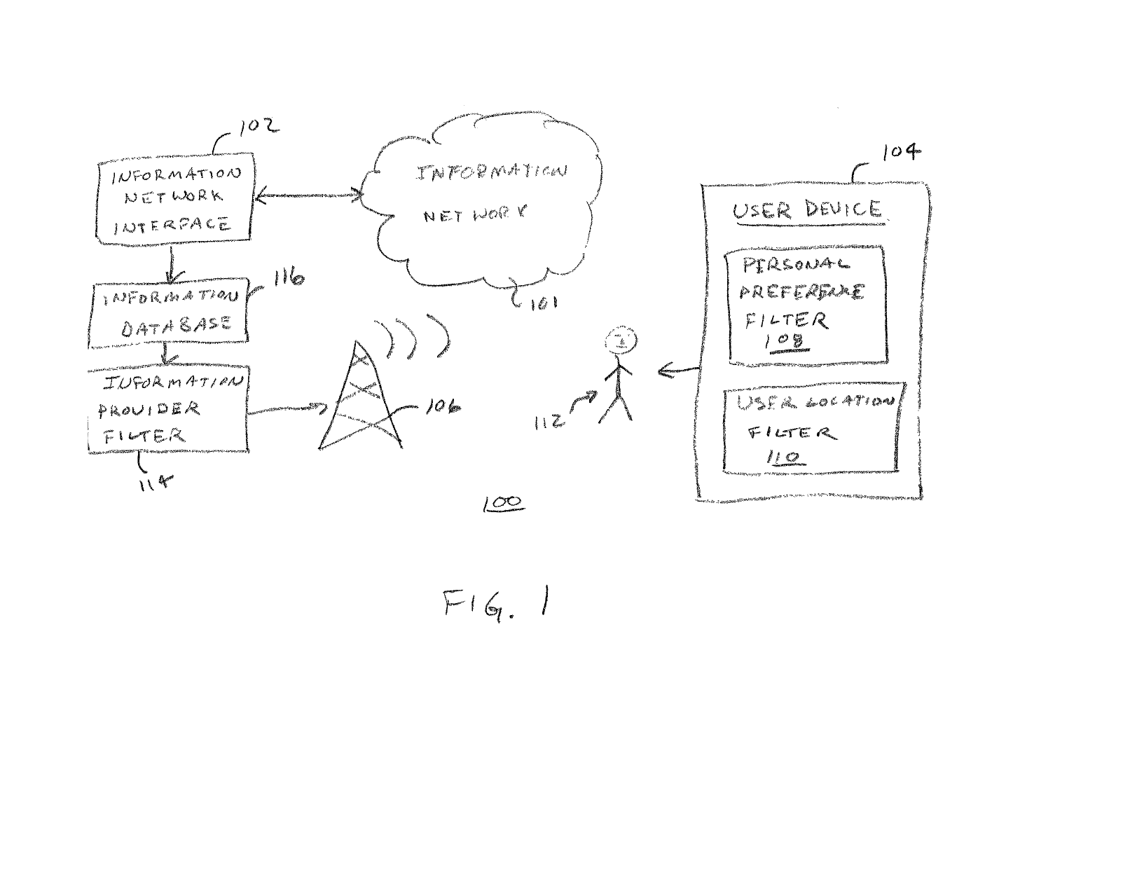

FIG. 1 depicts a block diagram of an information distribution system 100 in accordance with the present invention. The information distribution system 100 comprises an information network interface 102, an information database 116, an information provider filter 114, a broadcast transmission network 106, and a user device 104. The system 100 delivers personalized and location-specific information to a user 112. Although the preferred embodiment of the present invention is described below regarding mobile users, it should be understood that the present invention can be employed to deliver information to users in general.

The information network interface 102 collects information from an information network 101 that carries voice, video, and data on various voice, video and data networks. Examples of information collected from, for example, a voice network include, but are not limited to, voice messages and both two-way and multiway telephone conversations. Video information includes, but is not limited to, movies, maps, paintings, and documents. Information collected from data networks include, but are not limited to, text, data, and other information available on the Internet. Broadcast information on these networks includes, but is not limited to, radio, television, and other datacasting methods. The collected information is stored in the information database 116.

The information database 116 comprises the entirety of collected information. The information provider filter 114 selects a subset of the collected information to be delivered to the user device 104. The subset of information is chosen based on criteria established by a particular information provider, such as, but not limited to, user statistics, user profiles, and available transmission bandwidth.

The subset of collected information is delivered to the user device 104 via the broadcast network 106. The broadcast network 106 comprises either or both terrestrial and satellite based networks that include, but are not limited to, cellular, personal communications service (PCS), multipoint multichannel distribution service (MMDS), local multipoint distribution system (LMDS), and broadcast networks. Multiple networks allow the present invention to select the optimum communication channel or system to deliver the filtered information to the user device 104. In addition, multiple networks allow for mobile users to travel to multiple locations, each having a different broadcast transmission network in place, while still having access to the personalized and location specific information provided by the present invention.

In one embodiment of the invention, the broadcast network 106 comprises a television broadcast network. The television broadcast network broadcasts a digital television signal, such as a high definition television (HDTV) signal. The present invention uses a portion of the bandwidth allocated to digital television signals to datacast the information to the user device 104. Using television broadcast networks to deliver the information to the user device 104 eliminates the need to pay for what is commonly known in the art as “airtime” while receiving the information. Other networks, such as cellular and PCS networks, require the user to pay for the time it takes to request and receive the information.

Returning to FIG. 1, the user device 104 receives the broadcast information from the broadcast network 106. The user device 104 comprises a personal preference filter 108 and a user-location filter 110. The user device 104 filters the broadcast information to provide user-specific information to the user 112. Specifically, the personal preference filter 108 uses user preferences to separate and collate the broadcast information for the mobile user 112. User preferences are both pre-defined by the user 112 and are determined heuristically given the prior selections of the user 112.

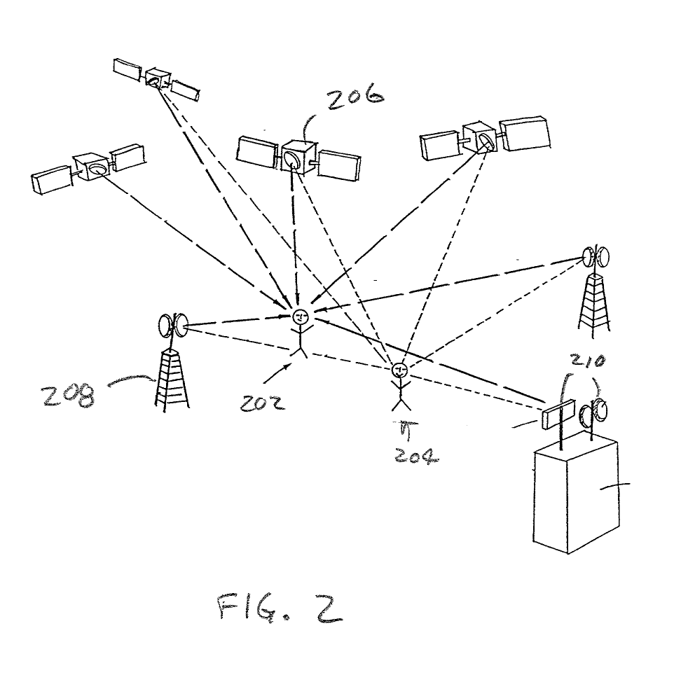

In one illustrative embodiment of the invention, the user-location filter 110 utilizes the user's location to further filter the broadcast information. The user's location is determined by the user device via location sensing methods illustrated in FIG. 2. FIG. 2 shows both a mobile user 202 and a stationary user 204. The location of either user 202 or 204 can be determined using a network of global positioning system (GPS) satellites 206. Additional location sensing methods include a network of terrestrial base stations 208 or smart antennas 210. Smart antennas 210 comprise planar and phased array antennas that facilitate determining position through triangulation techniques.

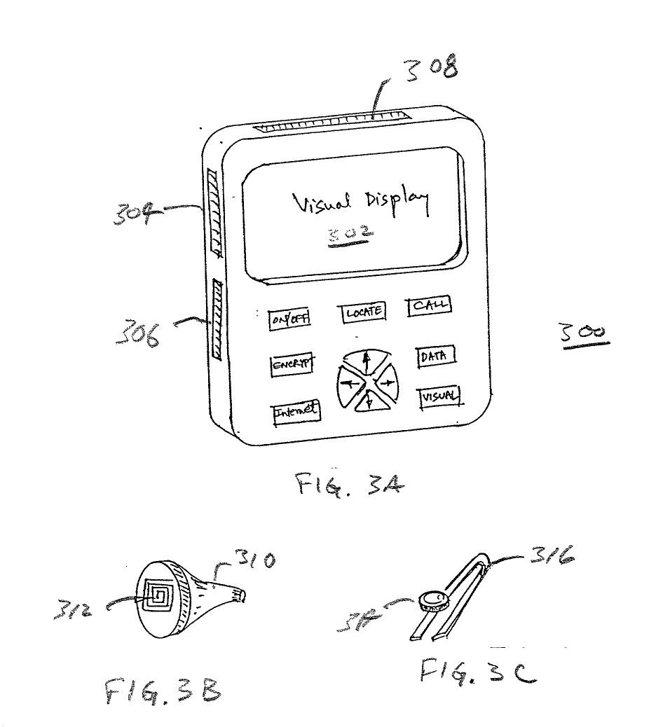

FIG. 3 depicts an apparatus 300 (a specific embodiment of a user device 104 of FIG. 1) for receiving information distributed by the present invention. As depicted in FIG. 3A, the apparatus 300 comprises a display 302, a multi-band antenna 304, wireless network transceiver 306, and a location sensor 308. FIG. 3B depicts a wireless earphone 310 having an antenna 312. FIG. 3C depicts a wireless microphone 314 having a support structure 316 shaped as a lapel pin.

The multi-band antenna 304 is capable of receiving signals from broadcast transmission networks, which include, but are not limited to, cellular, personal communications service (PCS), television broadcast, local multipoint distribution systems (LMDS), and multipoint multichannel distribution service (MMDS) networks. In one embodiment of the invention, the multi-band antenna 304 receives datacast information from broadcast television signals. Television stations could continually broadcast information such as news, stock quotes, and the like using, for example, bandwidth allocated within digital television signals. The apparatus 300 filters the datacasted information in accordance with the user's personal preferences and the user's location. The user's location is determined via the location sensor 308, which comprises, for example, a GPS antenna.

The wireless network transceiver 306 comprises a BLUETOOTH® or equivalent transceiver for short-range communications. The wireless network transceiver 306 communicates with the wireless earphone 310 and the wireless microphone 314 to deliver and receive information to and from the user. The presentation of information to the user is primarily in audio format via the wireless earphone 310, but the display 302 is present for visual presentations.

In one particular application for the invention, a camera comprises the invention. The camera determines its position and viewing direction via an on-board GPS receiver and a compass. In response to the location and viewing direction, the invention filters broadcast information to produce annotations that pertain to the location and direction such that the camera imbeds the particular annotations into the image or images. As such, time, date and the object being viewed could be annotated on the image. For example, at the zoo, images of particular animals cold be identified by the annotations on the images. The invention can be used in similar applications where information is made available to a user depending upon their viewing direction, location or both.

Although various embodiments which incorporate the teachings of the present invention have been shown and described in detail herein, those skilled in the art can readily devise many other varied embodiments that still incorporate these teachings.

What is claimed is:

1. A method of distributing information to a user comprising:
storing collected information in an information database;
transmitting some of the collected information as broadcast information over a broadcast network to a user device;
receiving the broadcast information in a user device; and
filtering, within the user device, said broadcast information to generate user-specific information.

2. The method of claim 1 further comprising:
transmitting some of the collected information in accordance with a predetermined criteria to generate a subset of the collected information.

3. The method of claim 2 further comprises:
collecting the collected information from an information network that comprises one or more networks selected from a group consisting of a voice network, a video network, and a data network.

4. The method of claim 1 wherein said transmission step comprises:
inserting said broadcast information into a digital television signal; and broadcasting said digital television signal.

5. The method of claim 1 wherein said filtering step comprises:
determining a location of the user; and
filtering said broadcast information based on said location.

6. The method of claim 5 wherein said location of the user is determined by a global positioning system (GPS).

7. The method of claim 5 wherein said location of the user is determined by a network of terrestrially based wireless stations.

8. The method of claim 1 wherein said filtering step comprises:
determining an information preference of the user; and
generating said user-specific information based on said information preference.

9. The method of claim 8 wherein said information preference is pre-defined by the user.

10. The method of claim 8 wherein said information preference is determined heuristically.

11. The method of claim 5 further comprising:
determining a viewing direction of the user device; and
wherein said user-specific information corresponds to the viewing direction and location of the user device.

12. A system for distributing information to a user comprising:
a database for storing information collected from an information network as collected information;
a broadcast network for transmitting at least some of the collected information as broadcast information; and
a user device for receiving the broadcast information, having a user filter for filtering the broadcast information and generating user-specific information.

13. The system of claim 12 further comprising:
an information provider filter for generating a subset of the collected information in accordance with a predetermined or heuristically learned criteria for transmission as the broadcast information.

14. The system of claim 13 wherein said information network comprises one or more networks selected from a group consisting of a voice network, a video network, and a data network.

15. The system of claim 12 wherein said broadcast network is a broadcast digital television network.

16. The system of claim 12 wherein said user filter comprises:
a personal preference filter for filtering said broadcast information in accordance with a user's personal preferences; and
a user location filter for filtering said broadcast information in accordance with a user's location.

17. The system of claim 16 wherein said user's personal preferences comprises predetermined user preferences.

18. The system of claim 16 wherein said user's personal preferences comprises heuristically determined user preferences.

19. The system of claim 16 wherein said user's location is determined by a global positioning system (GPS).

20. The system of claim 16 wherein said user's location is determined by a network of terrestrially based wireless stations.
